(19) United States
(12) Patent Application Publication
(10) Pub. No.: US 2017/0098262 A1
(43) Pub. Date: Apr. 6, 2017

(54) SYSTEM AND METHOD FOR ONLINE VEHICLE SALES

(71) Applicant: THE REYNOLDS AND REYNOLDS COMPANY, Kettering, OH (US)

(72) Inventor: Robert BROCKMAN, Houston, TX (US)

(21) Appl. No.: 15/285,254

(22) Filed: Oct. 4, 2016

Related U.S. Application Data
(60) Provisional application No. 62/237,949, filed on Oct. 6, 2015.

(51) Int. Cl. G06Q 30/06; G06Q 10/10; G06Q 40/02

(52) U.S. Cl. CPC G06Q 30/0611; G06Q 40/02; G06Q 10/1095

(57) ABSTRACT

A method for online purchase of a vehicle from a retailer may include specifying a specific vehicle to an online sales computer system, the online sales computer system having an online sales process server. The method may also include estimating a payment range for the specific vehicle for a potential customer by the online sales process server and receiving at the online sales computer system a soft-pull credit report of the potential customer. In addition, the method may include determining financing options for the potential customer from information derived from the soft-pull credit report with the online sales process server and generating a deal summary using the online sales computer system. The method may include receiving an acceptance of the deal summary at the online sales computer system and accepting a deposit for the specific vehicle by the online sales computer system.

### CROSS REFERENCE TO RELATED APPLICATIONS

This application is a nonprovisional application which claims priority from U.S. provisional application No. 62/237,949, filed Oct. 6, 2015, which is incorporated by reference herein in its entirety.

### TECHNICAL FIELD/FIELD OF THE DISCLOSURE

The present disclosure relates generally to computerized systems and methods for a purchase of a vehicle.

### BACKGROUND OF THE DISCLOSURE

When purchasing a vehicle, traditionally the customer must go to a dealership or other vehicle sales location (hereinafter, collectively “retailer”), negotiate the price of the vehicle the customer wishes to purchase, negotiate financing terms, and negotiate the value of any trade-in vehicle the customer may wish to exchange. Most, if not all, of these negotiations and transactions take place at the retailer. Potential customers may find this process time-consuming and costly; further, the entire process of purchasing the vehicle may require multiple trips to the retailer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart of an online sales process consistent with at least one embodiment of the present disclosure.

FIG. 2 is a flowchart of a selection process consistent with at least one embodiment of the present disclosure.

FIG. 3 is a flowchart of an initiate deal process consistent with at least one embodiment of the present disclosure.

FIG. 4 is a flowchart of a hold & deliver process consistent with at least one embodiment of the present disclosure.

FIG. 5 is a depiction of an account access GUI consistent with at least one embodiment of the present disclosure.

FIG. 6 is a depiction of a display specific vehicle GUI consistent with at least one embodiment of the present disclosure.

FIG. 7 is a depiction of a price navigation GUI consistent with at least one embodiment of the present disclosure.

FIG. 8 is a depiction of a rebates and incentives GUI 336 consistent with at least one embodiment of the present disclosure.

FIG. 9 is a depiction of a rebates and incentives GUI 336 consistent with at least one embodiment of the present disclosure.

FIG. 10 is a depiction of a trade-in GUI 340 consistent with at least one embodiment of the present disclosure.

FIG. 11 is a depiction of an estimate payment GUI consistent with at least one embodiment of the present disclosure.

FIG. 12 is a depiction of a present and select financing options GUI consistent with at least one embodiment of the present disclosure.

FIG. 13 is a depiction of a credit application entry GUI consistent with at least one embodiment of the present disclosure.

FIG. 14 is a depiction of a guaranteed trade-in value GUI consistent with at least one embodiment of the present disclosure.

FIG. 15 is a depiction of a deal summary GUI consistent with at least one embodiment of the present disclosure.

FIG. 16 is a depiction of a deal summary agreement GUI consistent with at least one embodiment of the present disclosure.

FIG. 17 is a depiction of a schedule and delivery GUI consistent with at least one embodiment of the present disclosure.

FIG. 18 is a depiction of an embodiment of online sales computer system consistent with at least one embodiment of the present disclosure.

### SUMMARY

The present disclosure provides for a method for online purchase of a vehicle from a retailer. The method includes specifying a specific vehicle to an online sales computer system, the online sales computer system having an online sales process server. The method also includes estimating a payment range for the specific vehicle for a potential customer by the online sales process server and receiving at the online sales computer system a soft-pull credit report of the potential customer. In addition, the method includes determining financing options for the potential customer from information derived from the soft-pull credit report with the online sales process server and generating a deal summary using the online sales computer system. The method includes receiving an acceptance of the deal summary at the online sales computer system and accepting a deposit for the specific vehicle by the online sales computer system.

The present disclosure also provides for a method for online purchase of a vehicle from a retailer. The method includes specifying a specific vehicle to an online sales computer system, the online sales computer system having an online sales process server. The method also includes determining that the specific vehicle will be purchased with cash at the online sales process server and generating a deal summary using the online sales computer system. In addition, the method includes receiving an acceptance of the deal summary at the online sales computer system and accepting a deposit for the specific vehicle by the online sales computer system.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. Components and arrangements may be reordered and specific components may be omitted. Other components and arrangements may be repeated. In addition, the present disclosure may repeat reference numerals and/or letters in the various examples. This repetition is for the purpose of simplicity and clarity and does not in itself dictate a relationship between the various embodiments and/or configurations discussed.

As used herein, a “GUI” is a graphical user interface in which data may be displayed and entered. In certain non-limiting embodiments, the GUIs described below may be customized depending on the device on which they are displayed.

As used herein, “online” means connected to another computer through a network. Network includes, but is not limited to, the internet.

As used herein, “soft-pull credit check” refers to a credit check done of a potential customer that does not have an effect on the potential customer's FICO score.

As used herein, “specific vehicle” refers to an individual vehicle identified by a VIN.

As used herein, a “basic vehicle” refers to a vehicle representative of a group of vehicles for which at least make, model and year are identified.

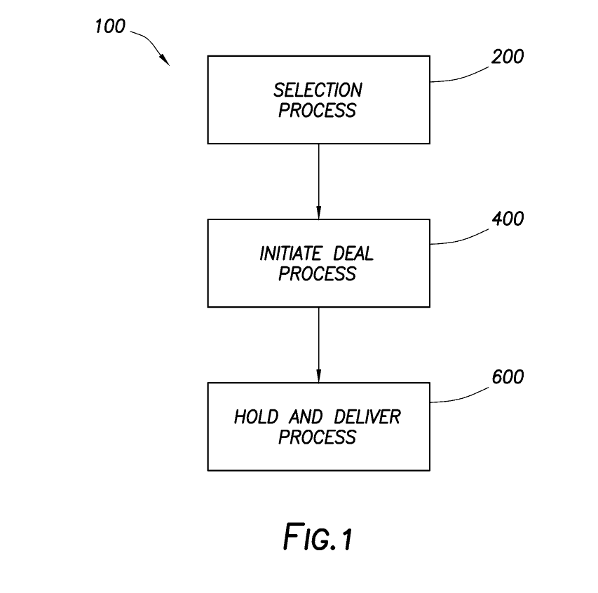

FIG. 1 depicts a flowchart of online sales process 100 consistent with certain embodiments of the present disclosure. As one of skill in the art will appreciate with the benefit of the present disclosure, online sales process may include steps performed with the benefit of computing devices and, in some embodiments, some steps without the benefit of computing devices. In the embodiment depicted in FIG. 1, three steps may be used for online sales process 100—selection process 200, initiate deal process 400, and hold & deliver process 600. Certain embodiments of the present disclosure may include only certain steps of online sales process 100 and not all three steps.

Online sales process 100 may be implemented in part by a series of related webpages. The related webpages may include GUIs for display or entry of data related to online sales process 100 generated by online sales computer system 700 as discussed hereinbelow. The related webpages may include instructions or other information about online sales process 100. One or more of the related webpages may include retailer website framing and branding. In addition, one or more of the related webpages may include information regarding commitment to purchase by the potential customer. In such embodiments, the one or more related webpages may include verbiage alerting the potential customer that they have no obligation to purchase a vehicle until an identified step in online sales process 100 and that the potential customer can cancel the potential deal. Certain pages of series of related webpages may link to one or more videos, slides, or text describing use online sales process 100 by the potential customer.

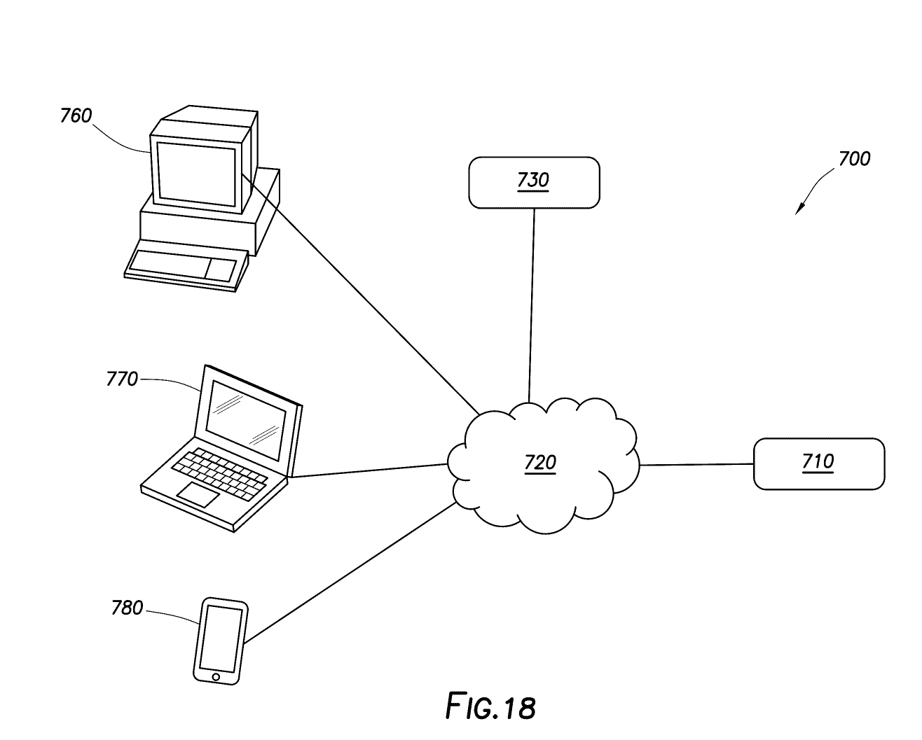

FIG. 18 depicts online sales computer system 700 upon which online sales process 100 may be executed in whole or in part. Online sales computer system 700 may include deal database server 710. Deal database server 710 may include the deal database in which information and documents regarding deals are stored. In the embodiment shown in FIG. 18, deal database server 710 may be accessed, such as through network 720, by online sales process server 730. Online sales process server 730 may be a dedicated server for use with online sales process 100, a shared server which may execute code instructions for processes other than online sales process 100, or a plurality of servers, each server having code instructions for executing a portion of online sales process 100. Network 720 may include one or more local area or wide area networks. The wide area network may be the internet. Online sales computer system 700 may also include retailer inventory database server. Retailer inventory database server may include a retailer inventory database with vehicle specific vehicle information such as make, model, year, trim package, interior and exterior colors, transmission, engine, VIN and other specific vehicle information regarding specific vehicles in the retailer inventory or specific vehicles to which the retailer has access. In some embodiments, the retailer inventory database may include digital images of specific or basic vehicles. The retailer inventory database is stored on a non-transitory, computer readable medium. Retailer inventory database server may be accessed, such as through network 720, by online sales process server 730.

Online sales process server 730 may include instructions on a non-transitory, computer readable medium for performing the processes outlined above with respect to online sales process 100, generation and updating of GUI's, presentment of images, and data transmission to and receipt from remote devices 760, 770, 780. Remote devices 760, 770, 780 include, for example and without limitation, desktop computer 760, lap top computer 770, and mobile device 780. Remote devices 760, 770, 780 may be operated by a potential customer, customer, or a retailer employee.

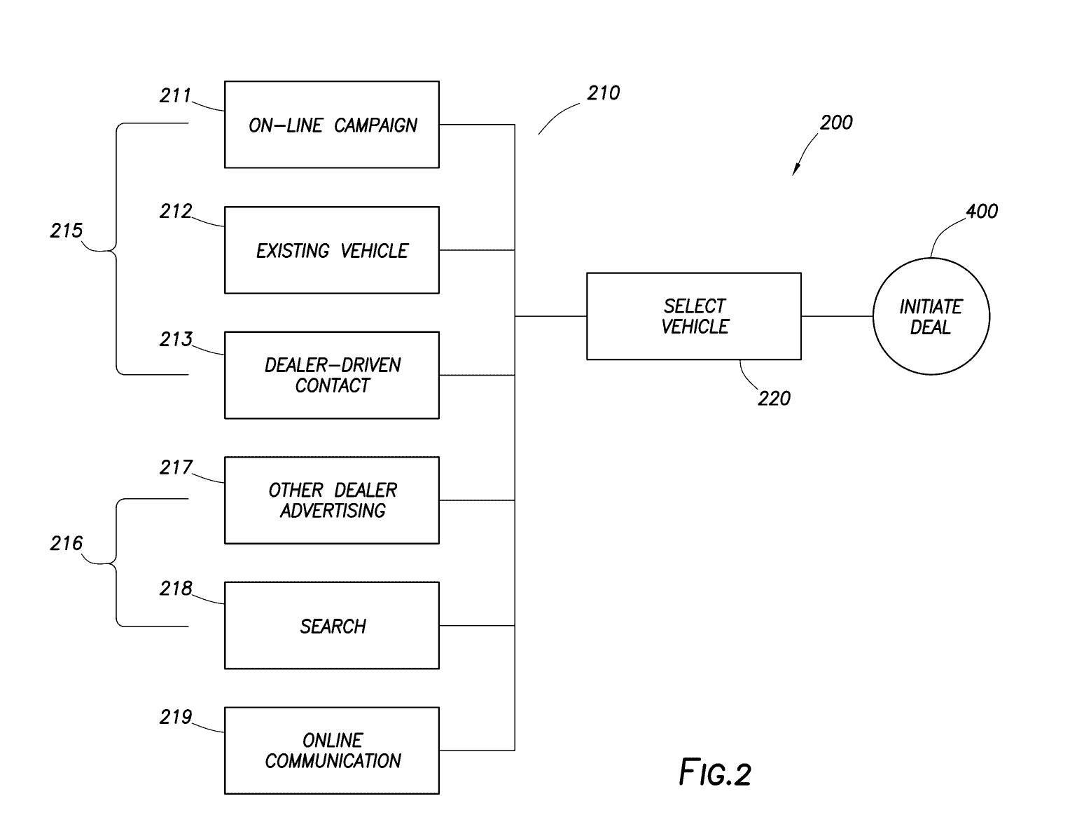

FIG. 2 depicts a flowchart of selection process 200 consistent with certain embodiments of the present disclosure. Selection process 200 may begin with research vehicle step 210 and end with select vehicle step 220. In research vehicle step 210, a potential customer for a vehicle may perform research on the vehicle the potential customer may wish to purchase.

Selection process 200 may also include retailer-initiated research 215. Retailer-initiated research 215 may include online methods of contacting potential customers initiated by a retailer. Retailer-initiated research 215 may be performed by the retailer itself or by an entity acting on behalf of the retailer. As used hereinafter, “retailer” includes entities acting on behalf of the retailer.

An example of retailer-initiated research 215 may be online campaign 211. In online campaign 211, potential customers or “prospects” may be contacted through a campaign, as described for instance, in U.S. Application No. 62/092,067, filed Dec. 15, 2014, which is incorporated herein in its entirety. In online campaign 211, a retailer may send a potential customer a campaign communication such as an e-mail, text message, other online communication, or contact the potential customer telephonically, wherein the potential customer may be selected by the retailer based on certain characteristics of the customer, the customer's vehicle, the last vehicle visit date (for example a sales or service anniversary) or demographic information about the customer known to the retailer or the original equipment manufacturer. The campaign communication sent by the retailer in online campaign 211 may include an imbedded “link” or other method of directing the customer to the retailer or original equipment manufacturer's website or other computing system for research into which vehicle the customer may wish to purchase. In certain embodiments, the imbedded link or other method of directing the potential customer to the retailer or original equipment manufacturer's website or other computing system may link to a specific vehicle, basic vehicle, or set of basic vehicles.

Another example of retailer-initiated research 215 may be an online communication from the retailer to a potential customer based on the potential customer's current vehicle, previous vehicle, or ongoing financial obligation related to the potential customer's current vehicle, shown as existing vehicle 212 in FIG. 2. In existing vehicle 212, the potential customer may receive an online communication based on the retailer's vehicle transaction customer database, a vehicle service customer database, or a third party database, such as a financial institution. Existing vehicle 212 may provide to the potential customer an imbedded link or other method of directing the potential customer to the retailer or original equipment manufacturer's website or other computing system and may link to a specific vehicle, basic vehicle, or set of basic vehicles. A non-limiting example of a system and method for existing vehicle 212 may be found in U.S. Pat. Nos. 8,355,950 and 8,527,349, which are herein incorporated fully by reference.

Another example of retailer-initiated research 215 may include dealer-driven contact 213. In dealer-driven contact 213, potential customers for vehicles or “prospects” may be identified from such sources as the internet, radio, television, social media such as Facebook, or billboards. Once identified, the potential customer's contact information may be gathered and, based on particular identifiers, assigned a follow-up activity. This follow-up activity may include an online communication. Dealer-driven contact 213 may provide to the potential customer in an online communication an imbedded link or other method of directing the potential customer to the retailer or original equipment manufacturer's website or other computing system and may link to a particular vehicle, type of vehicle, or subset of vehicle types. A non-limiting example of a system and method for dealer-driven contact 213 may be found in U.S. Application No. 62/092,067, filed Dec. 15, 2014, which is incorporated herein in its entirety.

As further depicted in FIG. 2, other options for research vehicle step 210 may include customer initiated research 216. For instance, other dealer advertising 217, such as, for instance, billboards, radio, television, direct mail, online commercials, may direct the potential customer, as part of the advertising, directions to select a website page associated with online sales process 100. Another option for customer initiated research may be a potential customer's own search, such as search 218. Search 218 may include, for example, in-person research by a potential customer. In-person research may mean that the potential customer physically inspects the retailer's inventory or gains online access to the retailer's online presence, such as a website that displays all or a portion of the retailer's inventory, for instance, as located on retailer inventory database server. Access to the retailers' online inventory may be managed by online sales process server 730.

As further depicted by FIG. 2, another option for research vehicle step 210 may include online communication 219. In online communication 219, a potential customer may be directed to select a website page associated with online sales process 100 by a retailer employee online, such as through the retailer's website. In one example, a potential customer may select to contact the retailer through an interface button on the retailer's website, such as a “contact us” button. A retailer employee may then communicate online with the potential customer and direct the potential customer to a website page associated with online sales process 100.

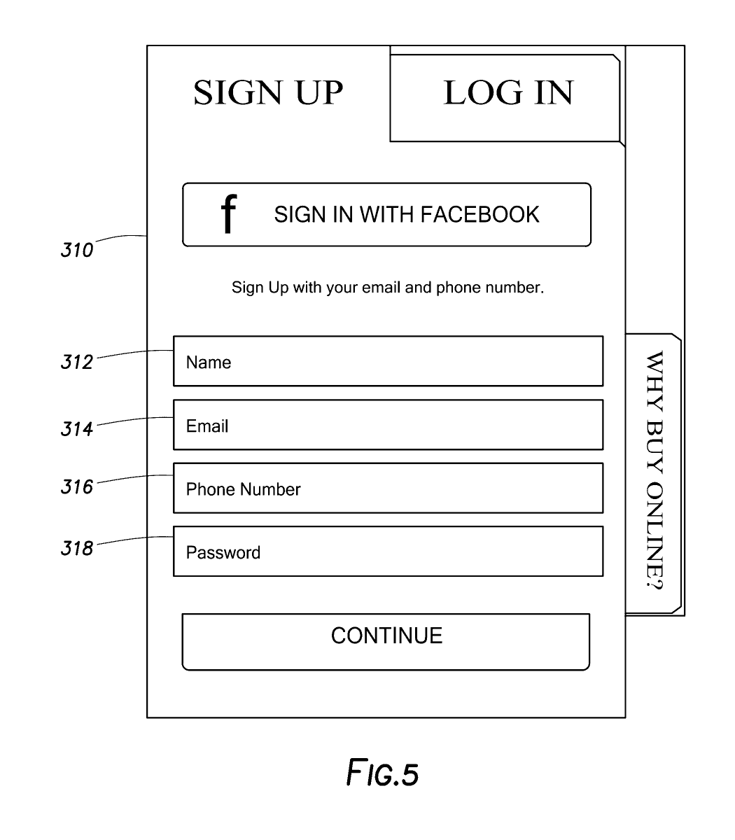

Online sales process 100 may include a prompt to the potential customer to create a new account or log in to an existing account through account access GUI 310 as shown in FIG. 5. When creating a new account, the potential customer may be prompted to enter identifying information including, but not limited to, the potential customer's name (through name entry field 312), phone number (through phone entry field 316), and e-mail address (through e-mail address entry field 314). The potential customer may also be prompted to generate a password in account access GUI 310 in password entry field 318. For potential customers with existing accounts, the potential customer may be prompted to enter a user-name or email address together with a password. Identifying information entered through account access GUI 310 or from an existing account may be used for a soft-pull credit check, as described hereinbelow.

Once logged in, online sales process 100 may include functionality that allows a potential customer that started, but did not complete online sales process 100 to continue online sales process 100 where the potential customer stopped during online sales process 100. In certain embodiments, cookies may be used to identify potential customers that have started, but not completed, online sales process 100.

In certain embodiments, when the potential customer creates a new account or logs in to an existing account, the retailer may be notified. In these embodiments, the retailer may assign a retailer employee to the potential customer, such as a salesperson. In some embodiments, the salesperson may monitor the potential customer's progress in online sales process 100. In certain embodiments, the potential customer may monitor the potential customer's progress in online sales process 100. In particular embodiments, the salesperson and the potential customer may communicate through a “chat” function, or otherwise online, such as through e-mail or text communications.

If the potential customer creates an account or logs in to an existing account, the retailer may store information related to the potential customer in a database of retailer prospects, that is, potential customers that the retailer may target with other communications even if the potential customer does not complete online sales process 100. As the customer proceeds through online sales process 100, information related to the potential customer and the vehicles considered by the potential customer may be added to the database of retailer prospects.

In the embodiment depicted in FIG. 2, after research vehicle step 210, the potential customer may be directed to select vehicle step 220. Select vehicle step 220 may be performed through a wide area network, such as the internet, or through a computer at the retailer. Computer as used herein may mean any computing device, including, but not limited, to a server, a desktop computer, a laptop computer, or a mobile computing device. Instructions for performing the steps of research vehicle step 210 may be executed through an application, such as on a mobile computing device, or be resident on the computing device, such as a server, desktop computer or laptop computer. In certain embodiments, the potential customer may be directed to a select vehicle GUI from a website page associated with online sales process 100. In some embodiments, the potential customer may be directed to a specific or basic vehicle through select vehicle step 220 through the imbedded link in research vehicle step 210.

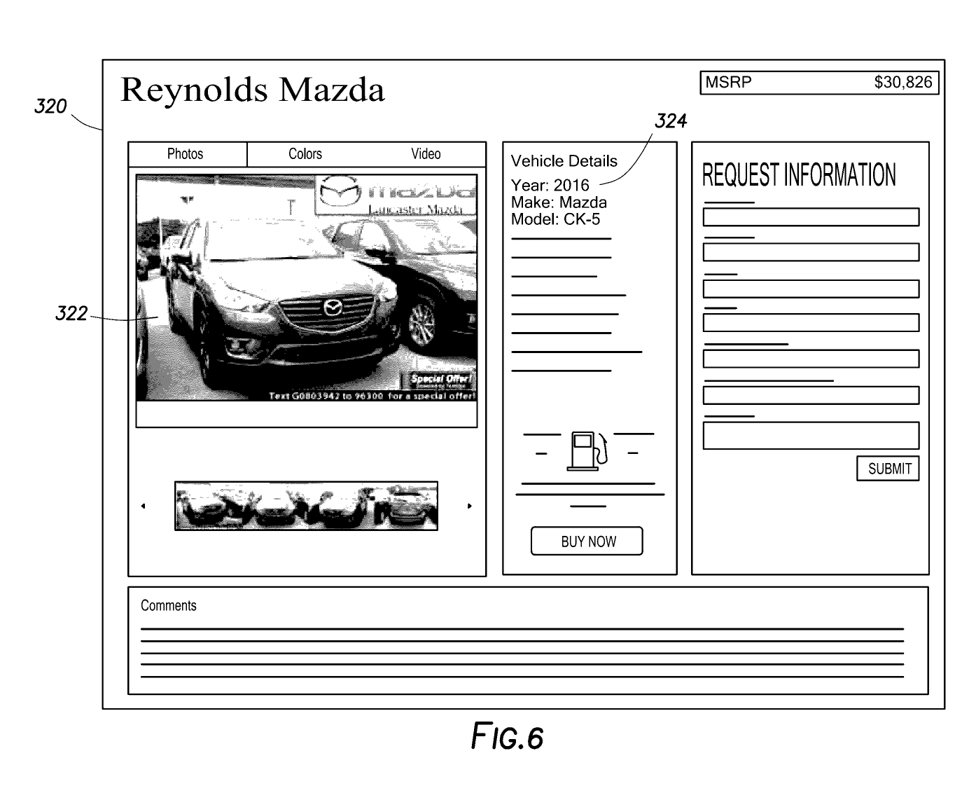

In select vehicle step 220, the potential customer may select a specific vehicle for potential purchase. In certain embodiments, the potential customer may specify more than one specific vehicle. In some embodiments, the potential customer may be limited to vehicles currently available at the retailer or vehicle sales entity. In other embodiments, the potential customer may select specific vehicles obtainable by the retailer in addition to those currently available. The specific vehicle or vehicles selected by the potential customer in select vehicle step 220 may be communicated online to the retailer. Once a specific vehicle has been selected by the customer, the information in display specific vehicle GUI 320 entered by the customer may be transmitted online to the retailer. As shown in FIG. 6, display specific vehicle GUI 320 may include vehicle image 322 and vehicle information 324. In certain embodiments, specific vehicle image 322 may be an image of a specific vehicle or a basic vehicle. Vehicle information 324 may include information about the specific vehicle including, for example and without limitation, year, make, model, trim, style, exterior color, interior color, transmission, engine, the retailer stock number and VIN.

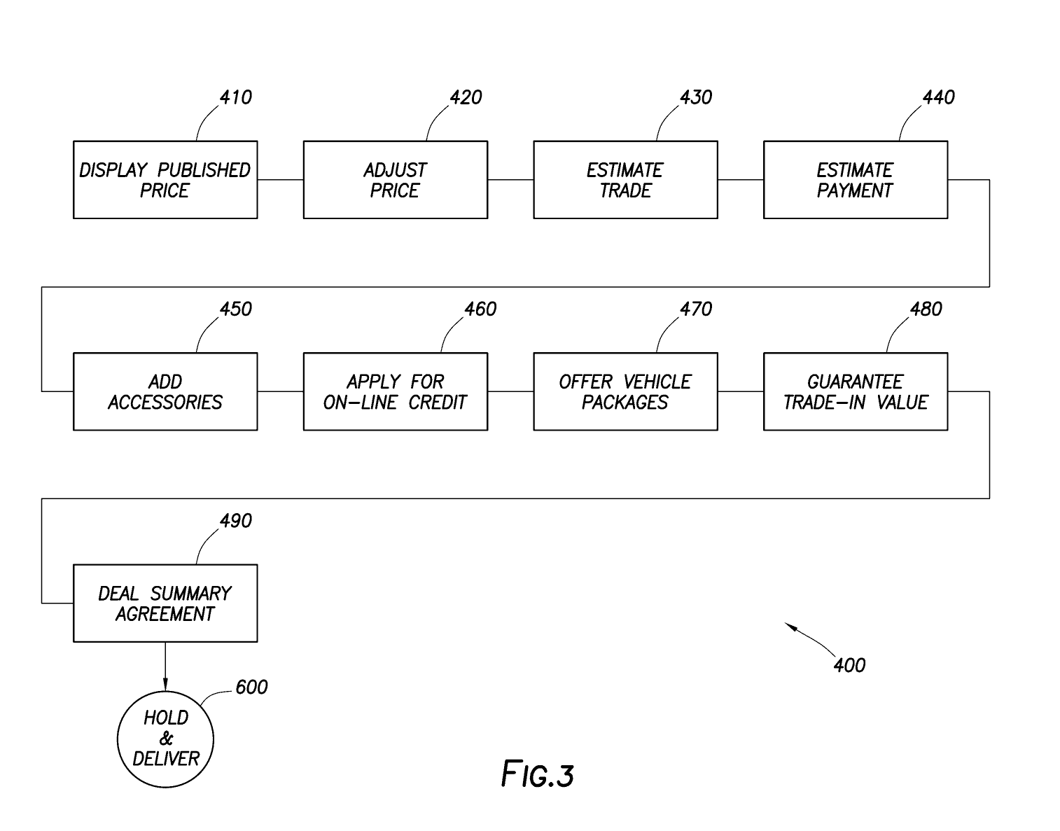

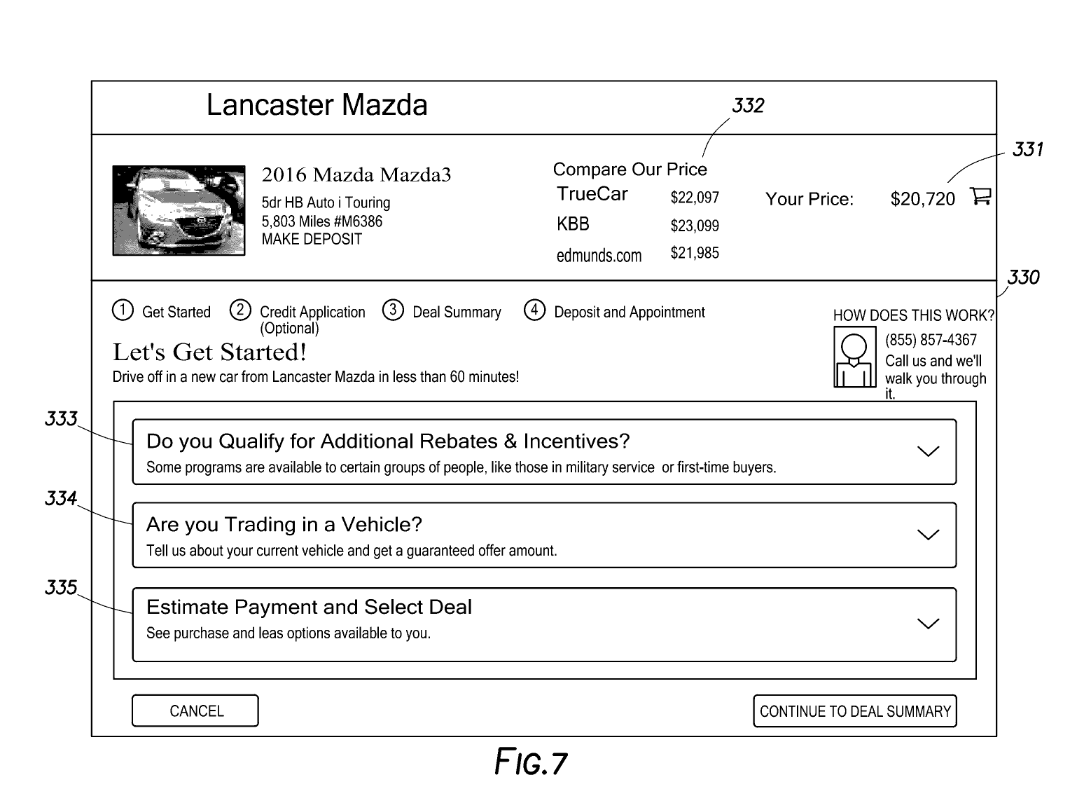

Once the customer has selected the vehicle in select vehicle step 220, in certain embodiments of the present disclosure such as that shown in FIGS. 2 and 3, a deal for the specific vehicle may be initiated in initiate deal process 400. Initiate deal process 400 may include online display of published price of the vehicle in display published price step 410. In display published price step 410, the retailer's price without rebates or incentives may be displayed online to the customer. The published price may be the MSRP, a price discounted from the MSRP, a selling price not including fees or, taxes, or a total price including fees and taxes. The published price may be displayed, for instance, in price navigation GUI 330 as shown in FIG. 7. In the non-limiting example shown in FIG. 7, published price 331 is a total price without rebates or incentives specific to the potential customer. In some embodiments, the total price may be adjusted to reflect incentives or rebates offered by the retailer or through the manufacturer based on the specific vehicle. In some embodiments, price navigation GUI 330 may display competitors' or vehicle valuation services' estimates of the value of the specific vehicle, as shown by comparison prices 332.

In certain embodiments, initiate deal process 400 may also include adjust price step 420. In adjust price step 420, the published price of the specific vehicle may be adjusted based on, for instance, incentives, rebates or other price adjustments that may apply to the specific vehicle based on characteristics of the potential customer. In certain embodiments, the rebates and incentives may be based in part on information previously received by the retailer regarding the potential customer, including, for instance, the customer's name, previous activities with the retailer, or the potential customer's credit history.

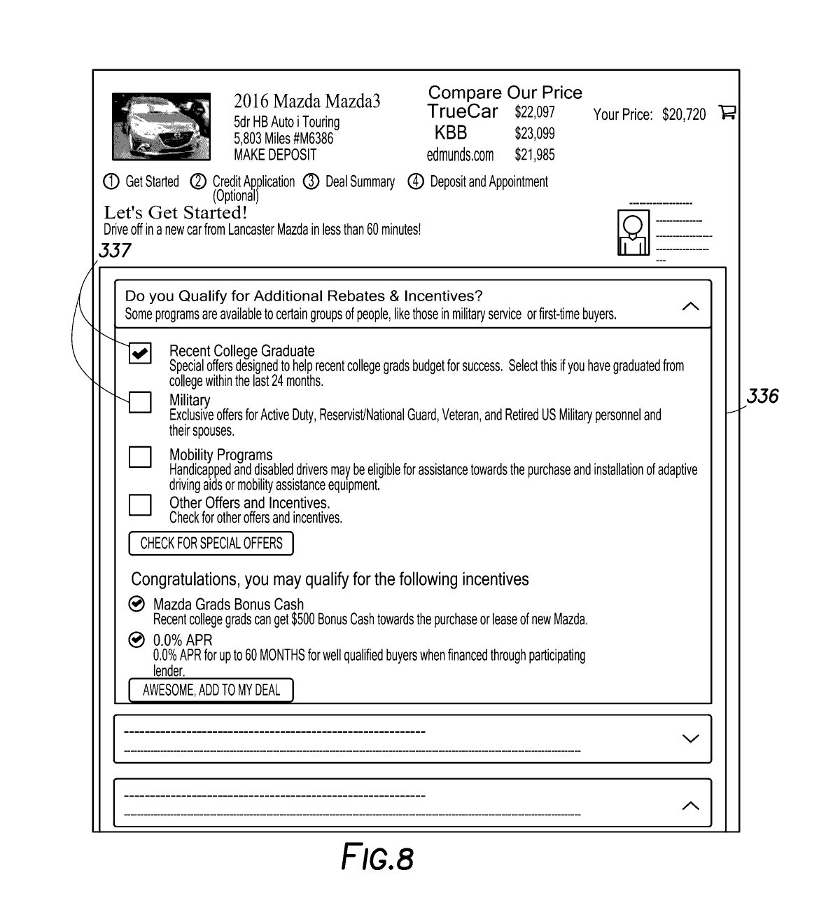

In some embodiments, adjust price step 420 may be omitted. In certain embodiments, available incentives, rebates and other price adjustments that apply based on the characteristics of a potential customer may be entered through rebates and incentives GUI 336, as shown on FIG. 8. Rebates and incentives GUI 336 may include one or more rebate and incentive designation buttons 337 for potential customer selection of rebates and incentives that apply to the potential customer. Other non-limiting examples of rebates and incentives may be related to specific vehicle, basic vehicles, makes, models, time of year or retailer. Information regarding rebates and incentives for populating the one or more rebates and incentive designation buttons 337 may be stored, for example and without limitation, in a database on online sales process server 730.

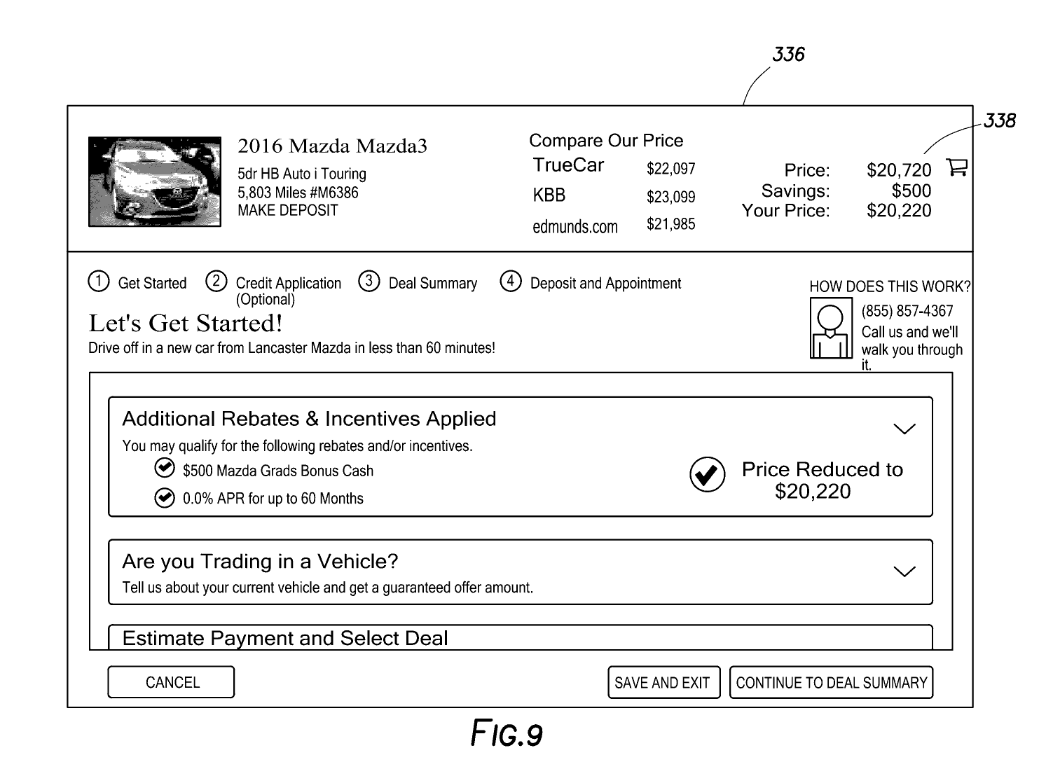

Once selected, for instance, through rebate and incentive designation buttons 337, applicable rebates and incentives may be applied by online sales process server 730 to the total price of the specific vehicle in price navigation GUI 330, as shown in FIG. 9 as adjusted price 338 (“your price” in the example shown in FIG. 9).

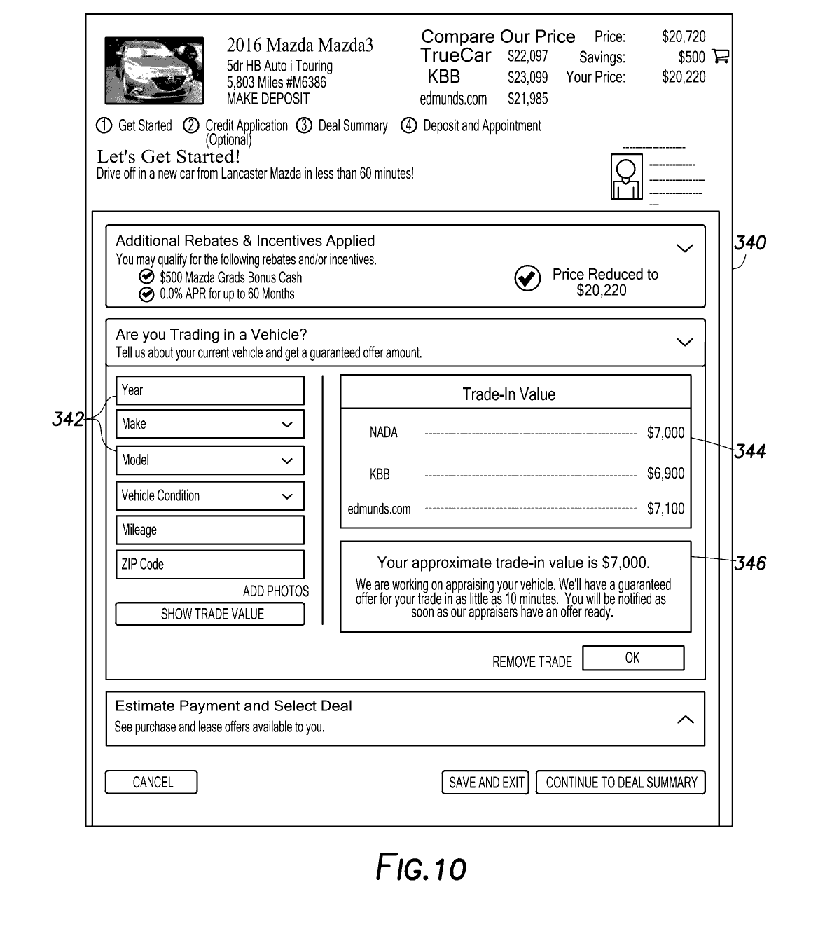

In certain embodiments, initiate deal process 400 may also include estimate trade-in step 430. While shown in FIG. 3 as following adjust price step 420, estimate trade-in step may occur at any point prior to guarantee trade-in value 480. In certain embodiments, such as when the potential customer is not trading in a vehicle or the potential customer only uses guarantee trade-in value 480, estimate trade-in step 430 may be omitted. In estimate trade-in step 430, the value of a potential customer's trade-in vehicle may be estimated by online sales process server 730. In certain embodiments, a potential customer may have multiple trade-ins. In certain embodiments, the value of the potential customer's trade-in vehicle may be estimated through accessing trade-in values from a trade-in value database, such as a third party database, by online sales process server 730. In some embodiments, more than one trade-in value database may be accessed to estimate the value of the trade-in vehicle and the multiple values averaged or otherwise combined to estimate the value of the trade-in vehicle. As shown in FIG. 10, in some embodiments, the potential customer may enter information regarding the trade-in vehicle with trade-in GUI 340 through trade-in vehicle entry fields 342. Based on information obtained through trade-in vehicle entry fields 342, trade-in GUI 340 may display the trade-in values from trade-in value databases in trade-in value display 344, together with an estimated trade-in value in estimated trade-in display 346.

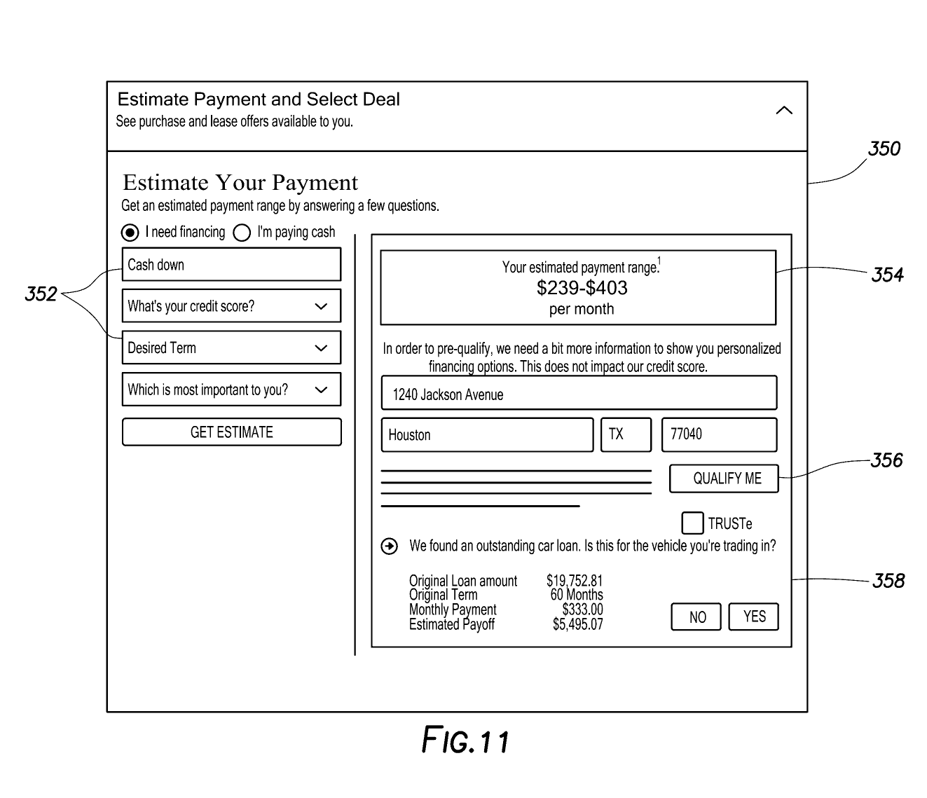

In certain embodiments, initiate deal process 400 may also include estimate payment step 440. In certain embodiments, such as, when the potential customer is paying cash for the vehicle or securing other financing, estimate payment step 440 may be omitted. Information for determining the estimated payment and presentation of an estimated payment range may be obtained through estimate payment GUI 350 as shown in FIG. 11. For examples, financing preferences, such as cash down, desired term, and lease versus buying options, as well as the potential customer's FICO score may be entered by the customer into estimate payment GUI 350 through financing entry fields 352. Other examples of financing preferences may include, but not be limited to maximum payment per month, term, number of miles driven annually, existing vehicle financing payments, and existing financing entity. An estimated payment range may be calculated by online sales process server 730 based, at least in part, on the information provided by the customer through financing entry fields 352. The estimated payment range may be presented through estimate payment GUI 350 in estimate payment range 354.

In some embodiments, a potential customer may obtain financing options through agreeing to a soft-pull credit report. “Financing options” include options for financing the vehicle that include such information as financing percentage rate (APR), term of the financing, finance charge, total payments, and amount of each payment. Financing options may include both sales and leasing options. After providing such information as customer name, address, city, state and zip code, the customer may authorize a soft-pull credit report. As shown in FIG. 11, the customer may authorize a soft-pull credit report through authorize button 356 (entitled “qualify me” in the example in FIG. 11”).

In certain embodiments of the present disclosure, estimate payment step 440 may include an evaluation of the potential customer's credit history from the soft-pull credit report to determine financing terms such as financing percentage rate or finance charges. In some embodiments, the evaluation of the potential customer's credit history may be used to determine if the potential customer is eligible for financing by the retailer. If in these embodiments, based on the evaluation of the potential customer's credit history, the potential customer is determined by the retailer to be eligible for retailer financing, the retailer may approve the potential customer for financing as part of estimate payment step 440. Further, if the potential customer is approved for retailer financing, the potential customer may be notified of the approval online by the retailer.

The potential customer's credit history may include the potential customer's credit score, e.g., FICO score and/or information related to prior auto loans. Information related to prior auto loans may include the original loan amount, estimated payoff, original term, remaining months, loan rate, monthly payment, times late on loan in the last 24 months, revolving credit, joint or individual, and auto inquiries in the last 30 days. In certain embodiments, such as that shown in FIG. 11, information regarding existing vehicle loans, and, therefore, potential trade-in vehicles, is shown in existing vehicle loans 358.

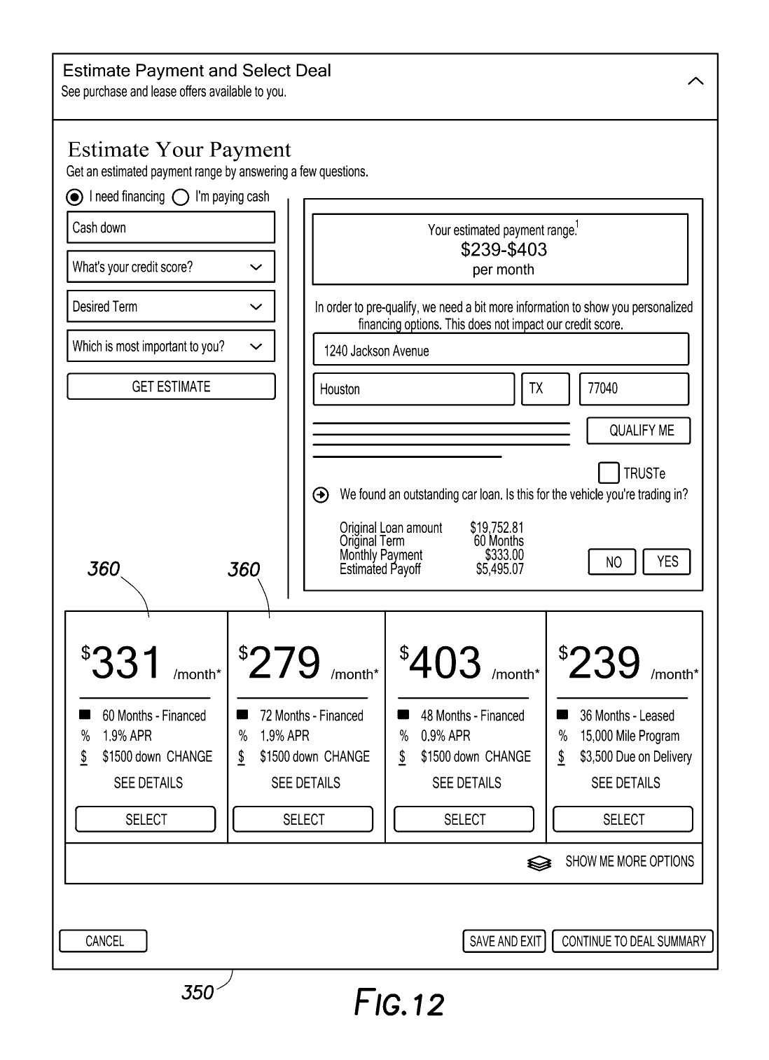

As shown in FIG. 12, based on information obtained from the soft-pull credit report, adjust price step 420, estimate trade-in step 430, financing entry fields 352, in some embodiments, one or more financing options 360 may be presented through present and select financing options GUI 350. In certain embodiments, financing options may be determined by online sales process server 730. In other embodiments, a retailer employee may determine the financing options. In certain embodiments, determination of financing options may include the use of an online negotiation system. An example of an online negotiation system that may be used in determining financing options is described in U.S. Application No. 62/061,006, which is fully incorporated by reference.

In certain embodiments, such as when the potential customer is securing financing through a source other than the retailer, or when the customer is paying cash for the vehicle, estimate payment step 440 may be omitted and the adjusted price may be used in place of financing options for deal summary agreement step 490.

Initiate deal process 400 may further include add accessories step 450. In add accessories step 450, the potential customer may select vehicle accessories to be added to the vehicle the potential customer has previously specified. Accessories may include body kits, electronics, exterior parts, interior parts, performance accessories, wheel accessories, wheels, and other accessories. In certain embodiments, as part of add accessories step 450, the potential customer may specify accessories, through for instance, an add accessories GUI. Another non-limiting example of the process of performing add accessories step 450 is U.S. Patent Application No. 62/237,921, filed Oct. 6, 2015, which is incorporated herein fully by reference. Accessories selected by the potential customer may be communicated online to the retailer.

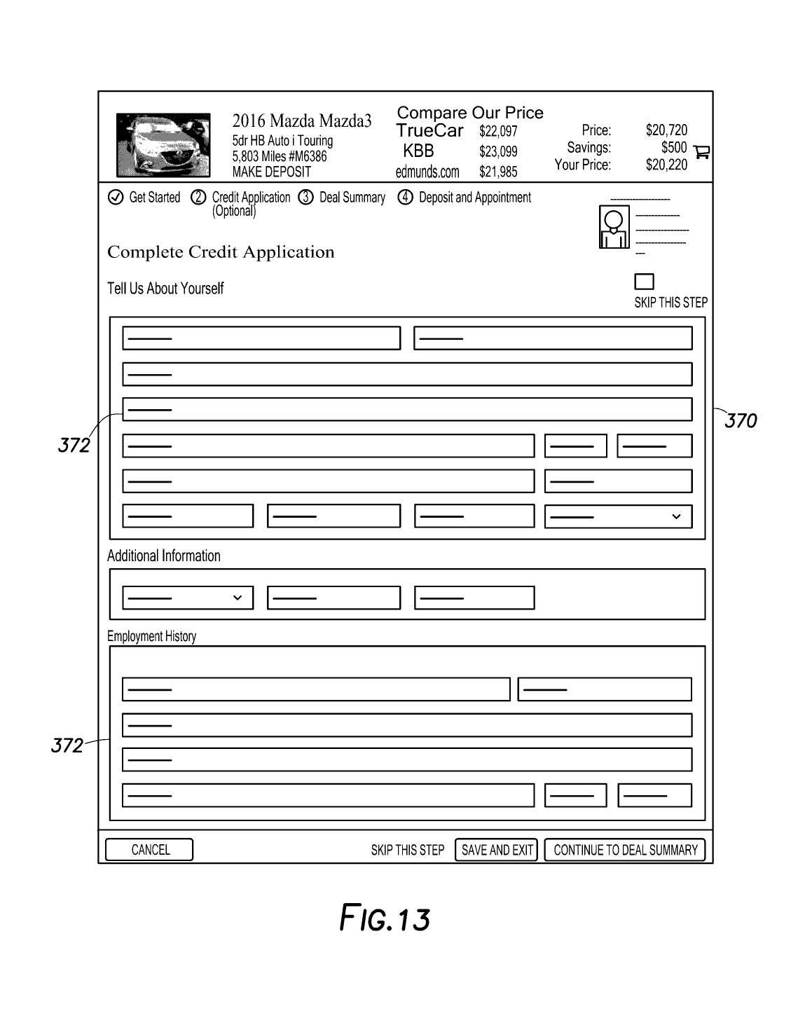

In certain embodiments, initiate deal process 400 may include apply for credit online step 460. In apply for credit online step 460, the potential customer may apply online for credit to purchase the selected vehicle. If the potential customer chooses to pay cash or arrange for private financing, apply for credit online step 460 may be omitted. In certain embodiments, as shown in FIG. 13, credit application entry GUI 370 may be used by the customer to input information needed for a credit application, including, for instance, name, address, social security number, and other personal identification. Information entered by the potential customer through credit application GUI 370, such as through credit application entry fields 372 may be transmitted online to the retailer. The retailer may then use the information received from the potential customer in apply for credit online step 460 to obtain a credit report associated with the potential customer. Based on the credit report received, the retailer may evaluate whether to extend credit to the potential customer, and, if the retailer chooses to extend, credit, determine under what financing terms the retailer offers credit to the potential customer. The retailer's decision on whether to extend credit to the potential customer and, if so, under what terms, may be communicated online to the potential customer.

Initiate deal process 400 may further include offer vehicle packages 470. Offer vehicle packages 470 may be an online communication from the retailer to the potential customer regarding vehicle packages that are available for purchase by the potential customer. Examples of such packages include guaranteed auto protection (GAP) insurance, rust proofing, and an extended warranty for the vehicle. Vehicle packages may be communicated online by the retailer to the potential customer. In certain embodiments, vehicle packages may be communicated to the potential customer via a vehicle package GUI. When vehicle package GUI is used, the potential customer may select through vehicle package GUI what packages, if any, the customer wishes to purchase. The vehicle packages selected by the potential customer may be communicated online to the retailer.

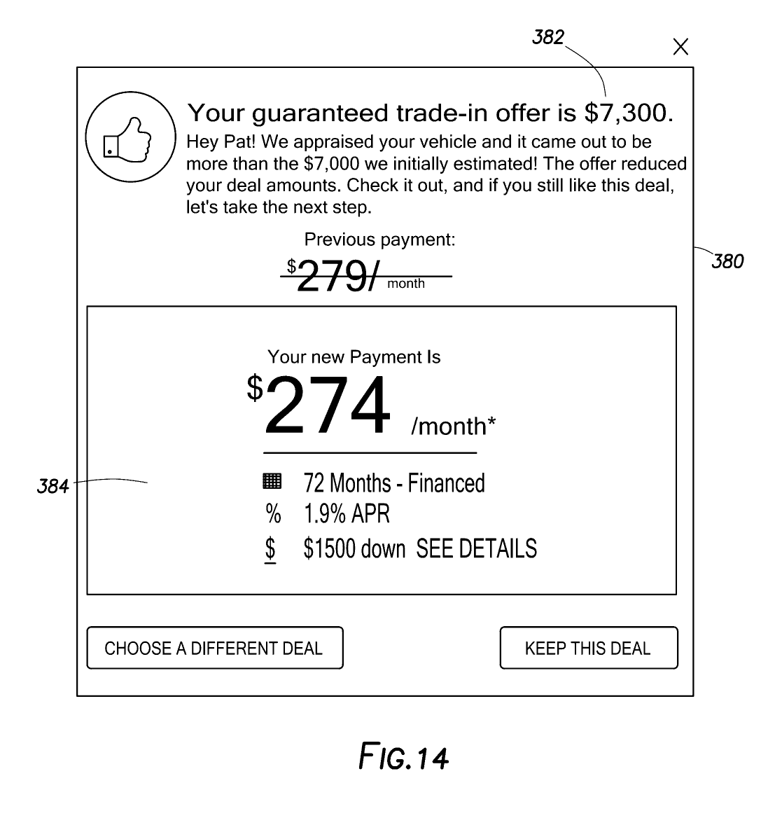

In some embodiments, initiate deal process 400 may also include guarantee trade-in value 480. In guarantee trade-in value 480, online sales process server 730 may access a guaranteed trade-in value database to access a guaranteed trade-in value for the trade-in of the potential customer. Assuming the information provided regarding the trade-in is accurate, in certain embodiments, the retailer may agree to be bound by the guaranteed trade-in value. In certain embodiments, the guaranteed trade-in value 382 and revised financing terms 384, based on the guaranteed trade-in value 382, may be presented to the customer through guaranteed trade-in value GUI 380 as shown in FIG. 14.

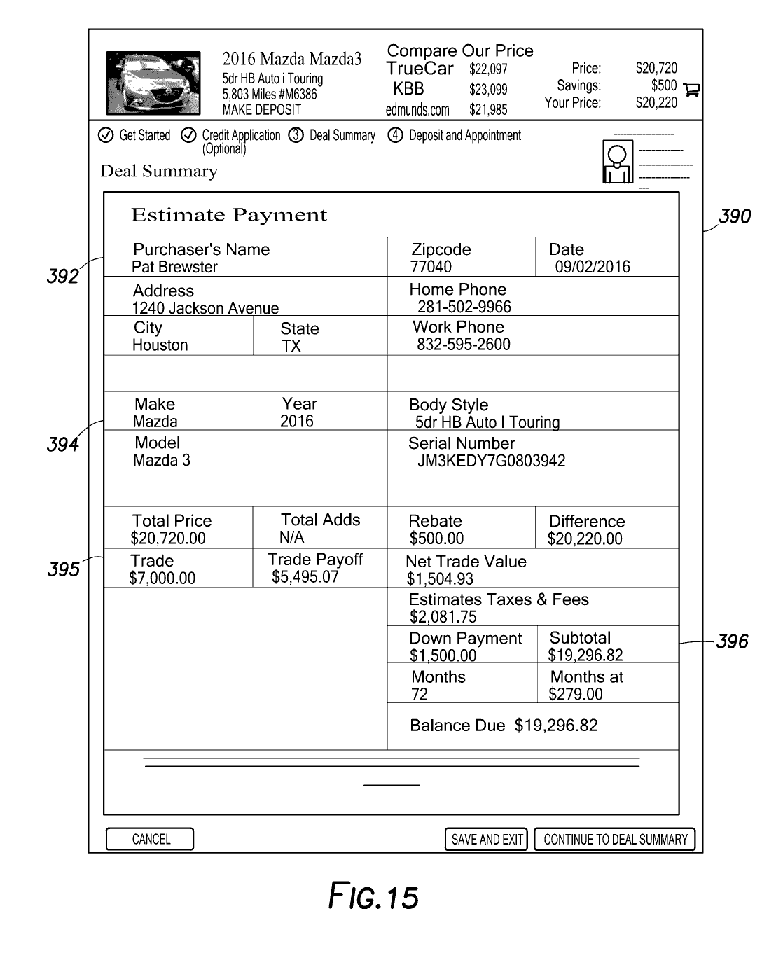

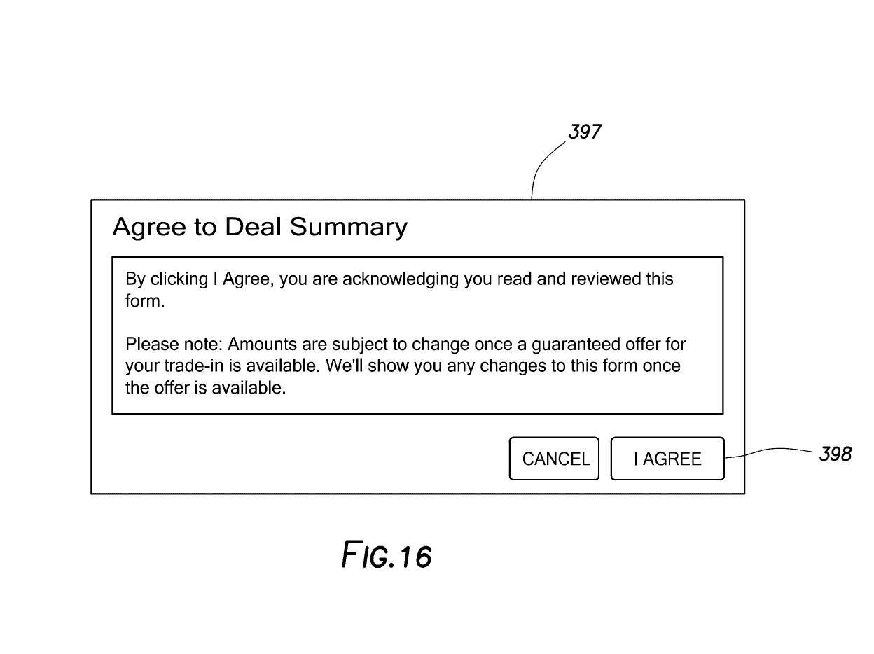

In some embodiments, initiate deal process 400 may also include deal summary agreement step 490. In deal summary agreement step 490, a summary of the deal from previous steps of initiate deal process 400 may be provided online to the potential customer, such as through deal summary GUI 390 as shown in FIG. 15. Deal summary GUI 390 may be generated, passed or displayed by online sales process server 730. Deal summary GUI 390 may include such information as purchaser information 392, specific vehicle information 394, trade-in information 395, and financing term information 396. The customer may accept the deal summary, such as through deal summary agreement GUI 397 by selecting agreement button 398, as shown in FIG. 16. The deal summary acceptance may be transmitted to online sales process server 730.

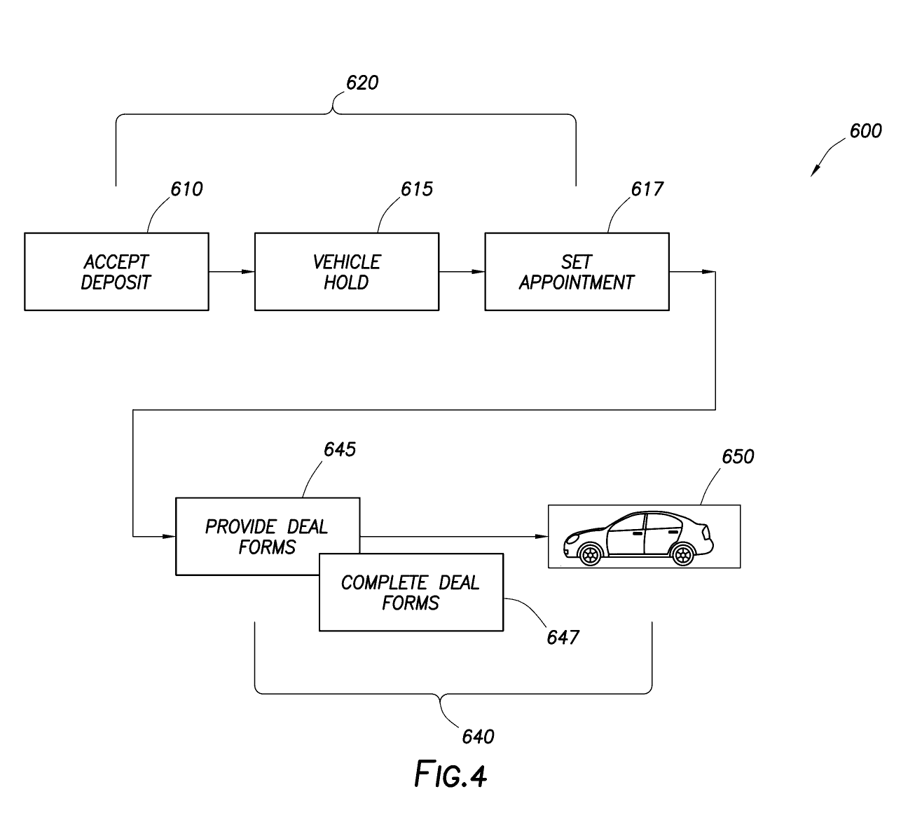

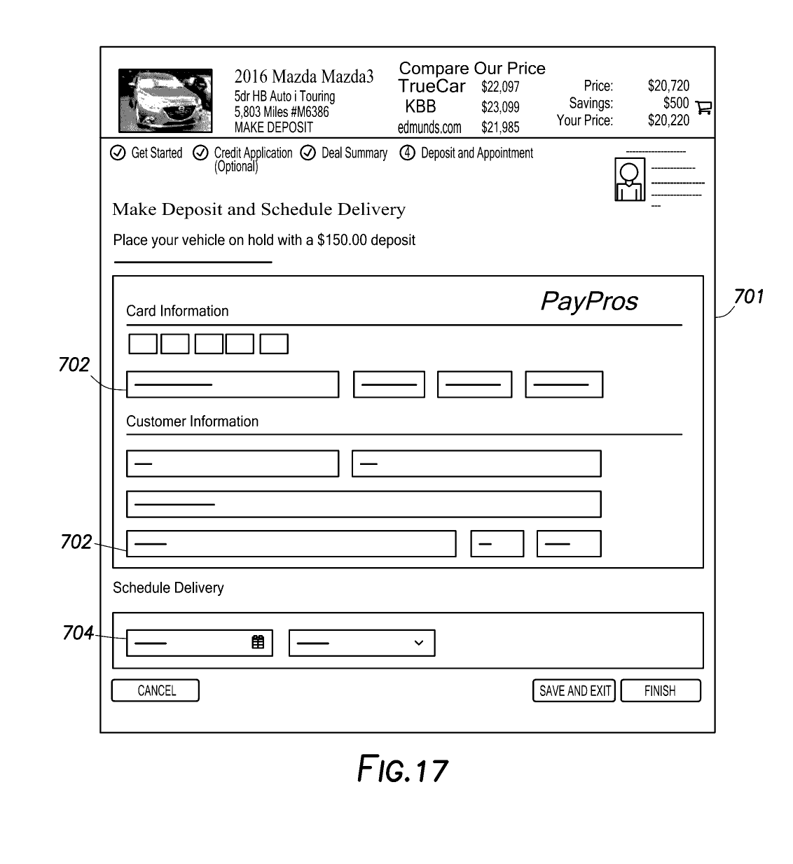

Following initiate deal process 400, the customer may proceed to online hold & deliver process 600 as depicted in FIG. 4. Online hold & deliver process 600 may include hold process 620 and deliver process 640. Hold process 620 may include, for instance, accept deposit step 610. In accept deposit step, the potential customer may pay the retailer and the retailer may accept a deposit on the vehicle selected. The deposit may be an online deposit. Non-limiting examples of an online deposit may be credit card, electronic checks, electronic payment, e.g., PayPal, or gift card. Accept deposit step 610 may be performed online by the customer, such as by providing deposit information through deposit entry fields 702 through deposit and schedule delivery GUI 701 as shown in FIG. 17. If the retailer accepts the deposit, the retailer may place a hold on the vehicle in vehicle hold step 615. Further, if the retailer accepts the deposit, the retailer may send a receipt to the potential customer online. In vehicle hold step 615, a “hold” is a notation on the retailer's computing systems that alerts retailer personnel that a potential customer has placed a deposit on the vehicle and the vehicle is not available for sale to a different potential customer. In certain embodiments, the notation on the retailer's computing systems may indicate that the vehicle is not available for sale. In other embodiments, the retailer's computing systems may be configured to no longer allow the vehicle to be viewed by potential customers and/or retailer salespersons. The hold may be temporary, i.e., the hold may expire after a set period of time, such as, in a non-limiting example a week, ten days, or a month. If the hold expires, in certain circumstances, the deposit may be refunded to the potential customer. If the potential customer purchases the vehicle, the deposit may be applied as a down payment on the vehicle. The hold may be placed through online sales process server 730 or by a retailer employee.

In certain embodiments of the present disclosure, after the hold in vehicle hold step 615 is placed, the potential customer may set an appointment for the potential customer to meet with retailer personnel, such as, a salesperson and or a service department employee in set appointment step 617 through delivery schedule entry field 704 in deposit and schedule delivery GUI 701. For instance, an appointment for a test drive of the vehicle selected by the potential customer may be set in set appointment step 617. Set appointment step 617 may be performed online, such, for instance, through e-mail. In certain embodiments, the scheduled meeting may be held online; in other embodiments, scheduled meeting may be held at the retailer or at a customer's residence, such as for a test drive of the selected vehicle. In addition, in some embodiments, an appointment may be set in set appointment step 617 for the delivery of the vehicle. In certain embodiments, the appointment may be only for the potential customer to take delivery of the vehicle. In certain embodiments, set appointment step 617 may be omitted.

Deliver process 640 may include provide deal forms step 645, complete deal forms step 647 and deliver vehicle step 650. In provide deal forms step 645, the retailer may provide the potential customer deal forms to complete the deal to purchase the vehicle. The retailer may provide deal forms online. In another embodiment, the retailer may provide the deal forms via e-mail. After completing the deal forms, the potential customer may return the completed deal forms in complete deal forms step 647 to the retailer online, and the retailer may receive the completed deal forms online. In such an embodiment, the forms may be signed by the customer using an electronic signature. In other embodiments, the potential customer may print out the forms, sign them, scan them, and send them to the retailer online, where the retailer receives the forms online, such as via e-mail. In yet other embodiments, in complete deal forms step 647, the potential customer may provide the completed deal forms to the retailer at deliver vehicle step 650. In other embodiments, provide deal forms step 645 and complete deal forms step 647 are performed at the retailer, where the retailer provides the potential customer the deal forms and the potential customer physically signs the deal forms. After completion of the deal forms and acceptance of the deal forms by the retailer, the potential customer becomes a customer of the retailer, as the deal is completed.

Following complete deal forms step 647, the retailer may deliver the vehicle to the customer in deliver vehicle step 650. The vehicle may be delivered to an address specified by the customer, or may be delivered to the customer at the retailer. In certain embodiments, as part of deliver vehicle step 650, the retailer may provide to the customer a completed delivery form. The completed delivery form may be provided to the customer online, such as via email.

Traditional methods do not include, for instance, instantaneous determination of the estimated value of a trade-in followed by a guaranteed trade-in value, coupled with the ability to determine potential financing terms and ultimately a deal summary.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method for online purchase of a vehicle from a retailer comprising:
specifying a specific vehicle to an online sales computer system, the online sales computer system having an online sales process server;
estimating a payment range for the specific vehicle for a potential customer by the online sales process server;
receiving at the online sales computer system a soft-pull credit report of the potential customer;
determining financing options for the potential customer from information derived from the soft-pull credit report with the online sales process server;
generating a deal summary using the online sales computer system;
receiving an acceptance of the deal summary at the online sales computer system; and
accepting a deposit for the specific vehicle by the online sales computer system.

2. The method of claim 1 further comprising receiving log-in information or new account information from a potential customer at the online sales computer system.

3. The method of claim 2, wherein the log-in information or new account information includes the customer name, phone number, and e-mail address.

4. The method of claim 1 further comprising after the step of specifying a specific vehicle:
displaying an image of the specific vehicle or a basic vehicle.

5. The method of claim 1 further comprising after the step of specifying a specific vehicle:
displaying a published price of the specific vehicle.

6. The method of claim 5 further comprising after the step of displaying a published price:
adjusting the published price of the specific vehicle by the online sales process server based on incentives, rebates, or other price adjustments to determine an adjusted price; and
displaying the adjusted price.

7. The method of claim 1 further comprising after the step of specifying a specific vehicle:
estimating a trade-in value for a potential customer's trade-in with the online sales process server.

8. The method of claim 7, wherein the step of estimating a trade-in value further comprises accessing trade-in values from a trade-in value database using the online sales process server to determine an estimated trade-in value.

9. The method of claim 8, wherein the step of estimating a trade-in value further comprises displaying the estimated trade-in value.

10. The method of claim 7 further comprising after the step of estimating a trade-in value:
receiving a guaranteed trade-in value database for the trade-in of the potential customer; and
presenting a guaranteed trade-in value for the trade-in of the potential customer.

11. The method of claim 1 further comprising after the step of determining financing options for the potential customer:
presenting financing options to the potential customer.

12. The method of claim 1 further comprising after the step of specifying a specific vehicle to an online sales computer system:
specifying an accessory to be added to the specific vehicle.

13. The method of claim 12 further comprising after the step of specifying an accessory:
specifying a vehicle package.

14. The method of claim 1 further comprising after the step of specifying a specific vehicle to an online sales computer system:
applying for credit online.

15. The method of claim 1, wherein the deposit is an online deposit.

16. The method of claim 15 further comprising:
accepting the deposit.

17. The method of claim 16 further comprising after accepting the deposit:
placing a hold on the specific vehicle on the online sales computer system.

18. The method of claim 1 further comprising after receiving an acceptance of the deal summary:
scheduling online a delivery appointment for the specific vehicle.

19. The method of claim 18 further comprising:
providing deal forms online to a potential customer.

20. The method of claim 19 further comprising after scheduling online a delivery appointment:
delivering the specific vehicle.

21. A method for online purchase of a vehicle from a retailer comprising:
specifying a specific vehicle to an online sales computer system, the online sales computer system having an online sales process server;
determining that the specific vehicle will be purchased with cash at the online sales process server;
generating a deal summary using the online sales computer system;
receiving an acceptance of the deal summary at the online sales computer system; and
accepting a deposit for the specific vehicle by the online sales computer system.

22. The method of claim 21 further comprising after the step of specifying a specific vehicle:
displaying an image of the specific vehicle or a basic vehicle.

23. The method of claim 21 further comprising after the step of specifying a specific vehicle:
displaying a published price of the specific vehicle.

24. The method of claim 23 further comprising after the step of displaying a published price:
adjusting the published price of the specific vehicle by the online sales process server based on incentives, rebates, or other price adjustments to determine an adjusted price; and
displaying the adjusted price.

25. The method of claim 21 further comprising after the step of specifying a specific vehicle:
estimating a trade-in value for a potential customer's trade-in with the online sales process server.

26. The method of claim 25, wherein the step of estimating a trade-in value further comprises accessing trade-in values from a trade-in value database using the online sales process server to determine an estimated trade-in value.

27. The method of claim 26, wherein the step of estimating a trade-in value further comprises displaying the estimated trade-in value.

28. The method of claim 26 further comprising after the step of estimating a trade-in value:
receiving a guaranteed trade-in value database for the trade-in of the potential customer; and
presenting a guaranteed trade-in value for the trade-in of the potential customer.

29. The method of claim 21 further comprising after the step of specifying a specific vehicle to an online sales computer system:
specifying an accessory to be added to the specific vehicle.

30. The method of claim 29 further comprising after the step of specifying an accessory:
specifying a vehicle package.

31. The method of claim 21, wherein the deposit is an online deposit.

32. The method of claim 31 further comprising:
accepting the deposit.

33. The method of claim 32 further comprising after accepting the deposit:
placing a hold on the specific vehicle on the online sales computer system.

34. The method of claim 21 further comprising after receiving an acceptance of the deal summary:
scheduling online a delivery appointment for the specific vehicle.

35. The method of claim 34 further comprising:
providing deal forms online to a potential customer.

36. The method of claim 35 further comprising after scheduling online a delivery appointment:
delivering the specific vehicle.
